(19) United States
(12) Patent Application Publication
(10) Pub. No.: US 2010/0272135 A1
(43) Pub. Date: Oct. 28, 2010

(54) Self-Seeded Wavelength Conversion

(76) Inventors: Dmitri Vladislavovich Kuksenkov, Painted Post, NY (US); Shenping Li, Painted Post, NY (US)

Correspondence Address: CORNING INCORPORATED, SP-TI-3-1, CORNING, NY, 14831, US

(21) Appl. No.: 12/430,970

(22) Filed: Apr. 28, 2009

(51) Int. Cl. H01S 3/10; H01S 3/13

(52) U.S. Cl. 372/22; 372/29.011; 372/25

(57) ABSTRACT

A method of operating a frequency-converted laser source is provided. According to the method, the gain section of a laser diode is driven such that the pulse repetition frequency ν_{P} of the laser source is less than but sufficiently close to a mathematical reciprocal of the round-trip light flight time t_{F} of the external laser cavity of the laser source, or an integer multiple thereof. In this manner, respective self-seeding laser pulses generated from the pulsed optical pump signal reach the gain section of the laser diode during buildup of successive optical pump signal pulses. Additional embodiments are disclosed and claimed.

### BACKGROUND

1. Field of the Disclosure

The present disclosure relates to frequency-converted laser sources and, more particularly, to a laser source employing second harmonic generation and gain-switched self-seeding.

2. Technical Background

Although the various concepts of the present disclosure are not limited to lasers that operate in any particular part of the optical spectrum, reference is frequently made herein to frequency doubled green lasers, where wavelength fluctuations of the diode IR source typically generate fluctuations of the frequency-converted green output power. Such fluctuations are often attributable to the relatively narrow spectral acceptance curve of the wavelength conversion device used in the frequency-converted laser—typically a periodically poled lithium niobate (PPLN) SHG crystal. If the aforementioned frequency-converted laser is used in a scanning projector, for example, the power fluctuations can generate unacceptable image artifacts. For the specific case when the laser comprises a two or three-section DBR laser, the laser cavity is defined by a relatively high reflectivity Bragg mirror on one side of the laser chip and a relatively low reflectivity coating (0.5-5%) on the other side of the laser chip. The resulting round-trip loss curve for such a configuration follows the inverse of the spectral reflectivity curve of the Bragg mirror. Also, only a discrete number of wavelengths called cavity modes can be selected by the laser. As the chip is operated, its temperature and therefore the refractive index of the semiconductor material changes, shifting the cavity modes relative to the Bragg reflection curve. As soon as the currently dominant cavity mode moves too far from the peak of the Bragg reflection curve, the laser switches to the mode that is closest to the peak of the Bragg reflection curve since this mode corresponds to the lowest loss—a phenomenon known as mode hopping.

Mode hopping can create sudden changes in output power and will often create visible borders between slightly lighter and slightly darker areas of a projected image because mode hops tend to occur at specific locations within the projected image. Sometimes, a laser will continue to emit in a specific cavity mode even when it moves away from the Bragg reflection peak by more than one free spectral range (mode spacing)—a phenomenon likely related to spatial hole burning and electron-photon dynamics in the cavity. This results in a mode hop of two or more cavity mode spacings and a corresponding unacceptably large change in output power. According to the subject matter of the present disclosure, laser configurations and corresponding methods of operation are provided to address these and other types of power variations in frequency-converted laser sources.

### BRIEF SUMMARY

In accordance with one embodiment of the present disclosure, a method of operating a frequency-converted laser source is provided. The laser source comprises a laser diode, coupling optics, a wavelength conversion device, and an external reflector. The laser diode is configured to emit a pulsed optical pump signal at a pump wavelength λ_{P} and a pulse repetition frequency ν_{P}. The laser diode, coupling optics, and external reflector are configured to define an external laser cavity defined between the laser diode and the external reflector along an optical path of the laser source. The wavelength conversion device is located along the optical path of the laser source within the external laser cavity and is configured to convert the pump wavelength λ_{P} to a converted wavelength λ_{C} and transmit a remaining unconverted pump signal λ_{P}′. The external reflector is configured to transmit the converted wavelength λ_{C} and return at least a portion of the unconverted pump signal λ_{P}′ to a gain section of the laser diode as a self-seeding laser pulse. According to the method, the gain section of the laser diode is driven such that the pulse repetition frequency ν_{P} is less than but sufficiently close to a mathematical reciprocal of the round-trip flight time t_{F} of the external laser cavity, or an integer multiple thereof, to ensure that respective self-seeding laser pulses generated from the pulsed optical pump signal reach the gain section of the laser diode during buildup of successive optical pump signal pulses. Additional embodiments are contemplated.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIGS. 1-6 are schematic illustrations of some of the frequency-converted laser sources in which the methodology of the present invention can be executed.

### DETAILED DESCRIPTION

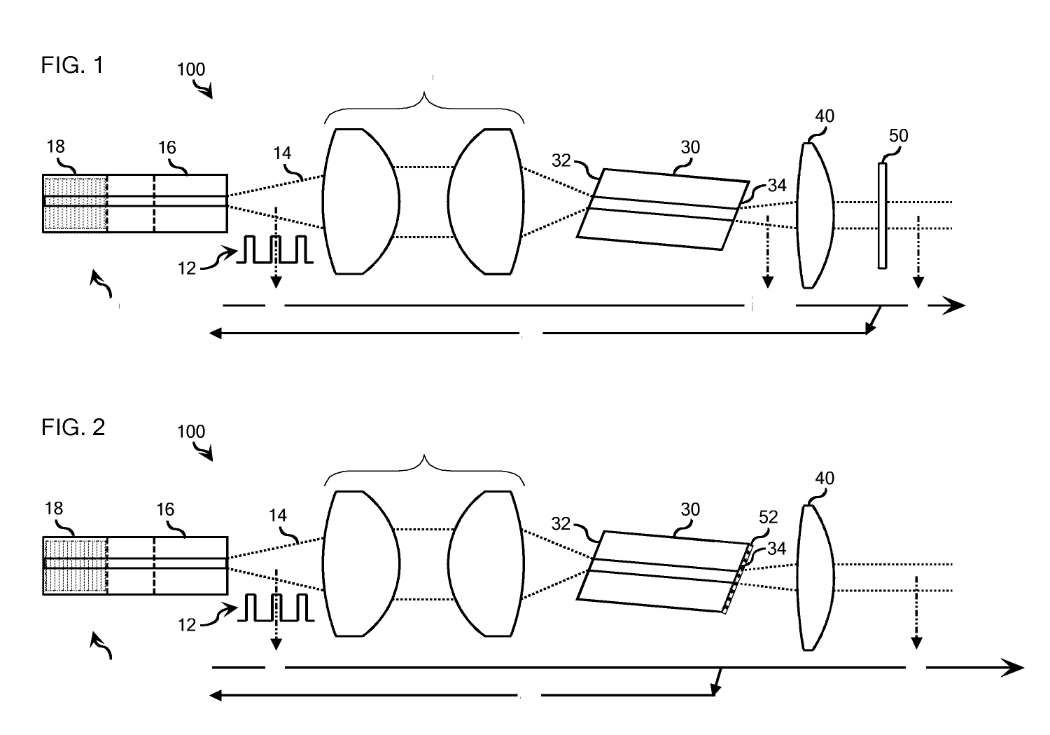

Referring initially to FIG. 1, according to one embodiment of the present disclosure, a frequency-converted laser source 100 comprises a laser diode 10 illustrated, for example as a DBR or DFB laser diode, coupling optics 20, a wavelength conversion device 30 presented, for example, as a waveguide PPLN crystal, collimating optics 40, and an external reflector 50, illustrated, for example, as a dichroic mirror. The laser diode 10 can be operated in a gain-switched mode to emit a pulsed optical pump signal 12 at a pump wavelength λ_{P} and a pulse repetition frequency ν_{P}. The laser diode 10, coupling optics 20, and external reflector 50 are configured to define an external laser cavity between the laser diode 10 and the external reflector 50 along an optical path 14 of the laser source 100.

The wavelength conversion device 30 is located along the optical path 14 of the laser source 100 within the external laser cavity and is configured to convert the pump wavelength λ_{P} to a converted wavelength λ_{C} and transmit a remaining unconverted pump signal λ_{P}′. The external reflector 50 is configured to transmit the converted wavelength λ_{C} and return at least a portion of the unconverted pump signal λ_{P}′ to the gain section 16 of the laser diode 10 as a self-seeding laser pulse. According to one embodiment, the gain section 16 is driven such that the pulse repetition frequency ν_{P} is less than but sufficiently close to a mathematical reciprocal of the round-trip flight time t_{F} of the external laser cavity, or an integer multiple thereof. By driving the laser source 100 in this manner, it is possible to ensure that respective self-seeding laser pulses generated from the pulsed optical pump signal 12 reach the gain section 16 of the laser diode during buildup of successive optical pump signal pulses.

More specifically, it is noted that the gain section 16 can be driven such that the pulse repetition frequency ν_{P} is synchronized with the round-trip light flight time t_{F} of the external laser cavity as follows

1/m(t_{F}+τ)≦ν_{P}<m/t_{F}

where m is a positive integer, τ is the approximate pulse width of the optical pump signal pulses, and the pulse repetition frequency ν_{P} is selected to allow respective self-seeding laser pulses generated from the pulsed optical pump signal to reach the gain section of the laser diode during buildup of successive optical pump signal pulses. For example, and not by way of limitation, it is contemplated that, for an external laser cavity having an effective cavity length (defined as a sum of physical length of all segments of the laser cavity multiplied by their respective refractive index) of about 3 cm and an approximate pulse width τ less than approximately 0.2 nsec, the pulse repetition frequency ν_{P} can be approximately 5 GHz. More specifically, for a 20 mm long external cavity with a 3 mm long semiconductor laser chip having a refractive index of 3.3 and a 10 mm long lithium niobate crystal having a refractive index of 2.3, the total effective external cavity length would be 33 mm and, therefore, the modulation frequency for achieving self-seeding operation would be approximately 4.545 GHz or one of its multiples. Thus, a 2.3 cm long, compact size self-seeded laser can be built, requiring a modestly high speed modulation of the drive current at 4.545 GHz. More generally, it is contemplated that, for an external laser cavity having an effective cavity length of between approximately 1.5 cm and approximately 5 cm and an approximate pulse width τ between about 0.04 nsec and about 0.2 nsec, the optimum pulse repetition frequency ν_{P} for any combination of these two parameters will be less than approximately 10 GHz.

Noting that the reflectivity of a thin-film dielectric coating can be designed to vary over a wide range (0.1-99.9%) as a function of wavelength, in FIG. 1, the external reflector 50 may comprise a dichroic mirror coating that is anti-reflective (AR) at the converted wavelength λ_{C} and highly reflective (HR) at the pump wavelength λ_{P}. Further, the front facet 32 of the wavelength conversion device 30, which faces the laser diode 10; can be HR coated at the converted wavelength λ_{C} and AR coated at the pump wavelength λ_{P}, which will allow “recycling” of the wavelength converted light produced by the reflected pump light propagating “backwards” through the wavelength conversion device. In cases where the wavelength conversion device is a waveguide in a nonlinear crystal, the front facet 32 should be “flat” (perpendicular to the waveguide) in order to reflect the converted wavelength λ_{C} back towards the external reflector 50. Similarly, the rear facet 34 of the wavelength conversion device 30, which faces the external reflector 50, can be AR coated at both the converted wavelength λ_{C} and the pump wavelength λ_{P}.

More specifically, in the embodiment illustrated in FIG. 1, the external cavity of the laser source is designed to provide synchronous feedback to the pulsed laser diode. The reflectivity of the dichroic mirror external reflector 50 at the pump wavelength λ_{P} can be established as high as possible (up to >99%), and the transmission of the reflector 50, at the converted wavelength λ_{C} should also be as high as possible (up to >99%). In this manner, the reflector 50, serves as the output coupler for converted light and the feedback reflector for the pump light. In addition, by operating the laser in a self-seeded gain-switched pulsing state, the stability of the laser output can be significantly improved by suppressing mode hops, which are a common problem in laser sources where an SHG or other type of wavelength conversion device is pumped by a single-mode semiconductor laser. The improvement in stability can be explained by considering the operating principle of the self seeding technique, where a semiconductor laser is gain modulated using a periodic electrical signal, such as a sinusoidal waveform, and a train of pump optical pulses are generated at a pulse repetition frequency ν_{P}. When the pulses pass through the wavelength conversion device 30, part of the pump light is converted and exits the source through the dichroic mirror external reflector 50, and part of the pump light is reflected by the dichroic external reflector 50 back to the gain section 16 of semiconductor laser 10 through the wavelength conversion device 30. When the feedback pulse enters the gain section 16 of the laser diode 10 during the buildup of the next pulse, i.e. when the laser is just below threshold, the feedback pulse, which carries the wavelength of the specific lasing mode as selected by the wavelength selective DBR section 18 of the DBR laser 10, becomes the seed light of the following pulse. Therefore, the dominant lasing mode of the preceding pulse is amplified by the laser amplifier before lasing buildup from spontaneous emission has the chance to occur in other modes. Thus, the disclosed technique favorably competes with spontaneous noise and the buildup of other cavity modes and enhances spectral purity and stability in the laser emission. To ensure this type of self-seeding feedback, the repetition rate of the pulse train, i.e., the pulse repetition frequency ν_{P} should be slightly smaller than the fundamental frequency of the external cavity, or one of its harmonics, as is noted above.

It is also noted that the disclosed technique improves conversion efficiency because the pulsed operation of the laser effectively increases the peak power of the pump light λ_{P} and, unlike conventional single-pass extra-cavity SHG configurations, the unconverted pump light is either reflected back to the pump laser 10 as the seed light or is converted during the second (“backwards”) pass through the wavelength conversion device 30.

Referring to FIG. 2, it is contemplated that the external reflector may comprise a dichroic mirror applied as a coating 52 on the rear facet 34 of the wavelength conversion device 30, in which case the front facet 32 of the wavelength conversion device 30 would be HR coated at the converted wavelength λ_{C} and AR coated at the pump wavelength λ_{P}. The rear facet 34 of the wavelength conversion device would be AR coated at the converted wavelength λ_{C} and HR coated at the pump wavelength λ_{P}. In cases where the wavelength conversion device is a waveguide in a nonlinear crystal, to provide the required reflection of pump light λ_{P} at the rear facet 34 and wavelength-converted light λ_{C} at the front facet 32, both facets should be “flat” (perpendicular to the waveguide). It is contemplated that the reflectivity of the dichroic coating 52 at the pump wavelength λ_{P} would typically be between approximately 10% and approximately 100%. At the converted wavelength λ_{C}, the coating 52 would exhibit high transmission (>99%). It is also noted that, in the configuration of FIG. 2, the embodiment minimizes the number of optical elements that would need to be aligned during assembly and calibration, as compared with conventional extra-cavity SHG configurations pumped by semiconductor lasers.

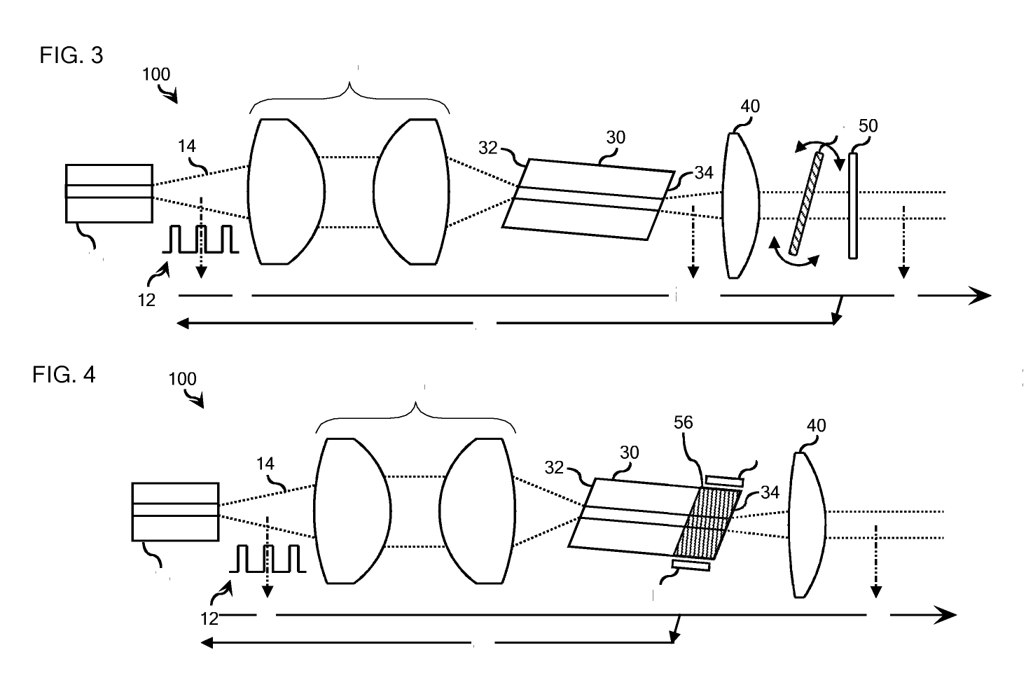

In the embodiments of FIGS. 3-6, the laser diode 10 is a nominally multiple longitudinal mode Fabry-Perot laser diode. The major difference of this type of configuration, as compared to the configurations of FIGS. 1 and 2, is that the self-seeding technique is also used to achieve single mode operation of the semiconductor laser pump. To do so, a wavelength selective reflector or filter is used in the external cavity to feed back only one of the longitudinal modes of the pump laser. When the feedback pulse enters the gain section of the laser diode 15 during the buildup of the next pulse, i.e. when the laser is just below threshold, the feedback pulse, which carries the wavelength of the specific lasing mode, becomes the seed light of the following pulse. Therefore, the dominant lasing mode of the preceding pulse is amplified by the laser amplifier before lasing buildup from spontaneous emission has the chance to occur in other modes. Thus, the disclosed technique favorably competes with spontaneous noise and the buildup of other cavity modes and enhances spectral purity and stability in the laser emission. To ensure this type of self-seeding feedback, the repetition rate of the pulse train, i.e., the pulse repetition frequency ν_{P} should be slightly smaller than the fundamental frequency of the external cavity, or one of its harmonics, as is noted above.

In FIG. 3, a band-pass filter 54 is positioned in the external cavity and is configured to transmit at the converted wavelength λ_{C} and at a relatively narrow band of the pump wavelength λ_{P}. Typically, the bandwidth of the relatively narrow band of the pump wavelength λ_{P} is less than the mode spacing of the laser diode, i.e., less than 1 nm. Further, the band-pass filter 54 comprises a tilting mechanism and is configured for tuning the relatively narrow transmission band of the band-pass filter through tilting. The front facet 32 of the wavelength conversion device is HR coated at the converted wavelength λ_{C} and AR coated at the pump wavelength λ_{P}. The rear facet 34 of the wavelength conversion device 30 is AR coated at the converted wavelength λ_{C} and at the pump wavelength λ_{P}. The external reflector 50 is AR coated at the converted wavelength λ_{C} and HR coated at the pump wavelength λ_{P}. In operation, the repetition rate of the pulse train, i.e., the pulse repetition frequency ν_{P} should be slightly smaller than the fundamental frequency of the external cavity, or one of its harmonics, as is noted above.

In FIG. 4, a Bragg grating reflector (BGR) 56 is integrated into the rear facet 34 of the wavelength conversion device 30. The bandwidth of the BGR should be less than 1 nm, and preferably smaller than the mode spacing of the semiconductor laser pump. One common way to write BGR in a nonlinear crystal is to form a periodic masking layer using photoresist exposed by a standard holographic technique and then use standard ion-milling to remove material in the unmasked areas. The center reflection wavelength of the BGR should be at one of the cavity modes of the pump laser. The reflectivity of the BGR is in the range from 5% to 100%. The center reflection wavelength (Bragg wavelength) of the BGR can be expressed as

λ_{B}=2nΛ

where n is the effective refractive index of the grating in the waveguide (or average refractive index if a bulk crystal is used) and Λ is the grating period. Given this relationship, the tuning of the Bragg wavelength can be achieved by either changing parameters n or Λ. For example, the refractive index n of a nonlinear crystal can be changed via the electro-optic effect by using control electrodes 60 to apply an electric field across the reflector 56. The grating period Λ and the refractive index n can be adjusted by controlling the temperature of the BGR 56 using any suitable temperature control mechanism.

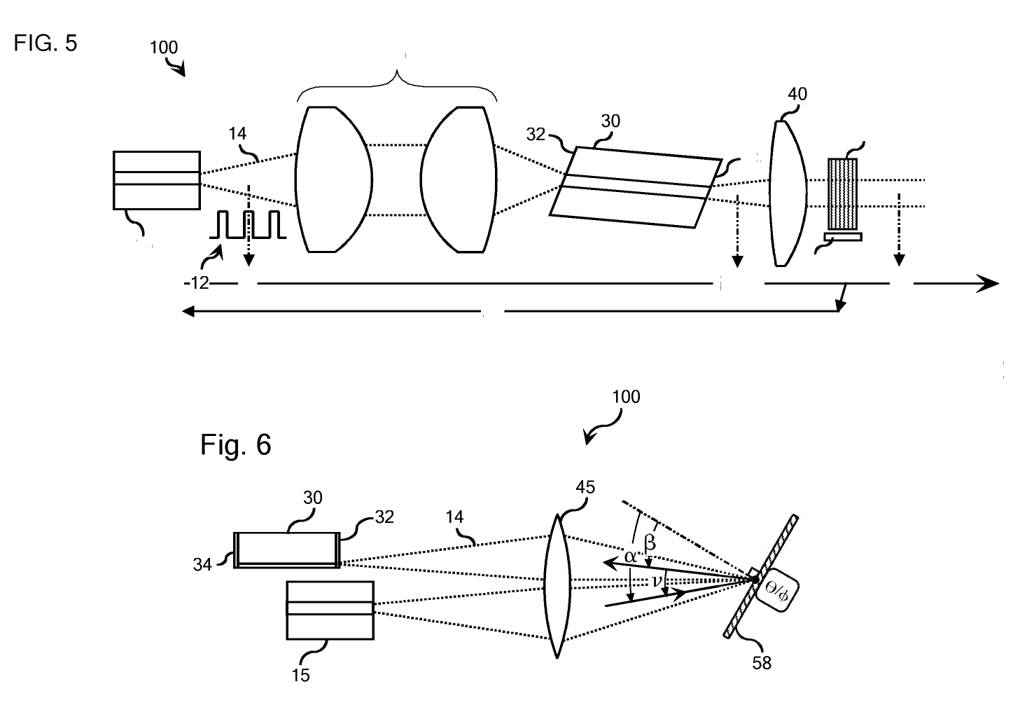

In FIG. 5, the external reflector is presented as a Bragg Grating (BGR) 56 that is displaced from the rear facet 34 of the wavelength conversion device 30. This BGR 56 can be made using an electro-optic crystal. The Bragg wavelength can be tuned by either applying electrical field to the crystal or controlling the temperature of the crystal. The BGR can be also made using photo-thermo-refractive glass or photo-sensitive glass. The relative shift in the Bragg wavelength, ΔλB/λB due to change in temperature (ΔT) is approximately given by:

$$\frac{{Δλ}_{B}}{{λ}_{B}} = ( {α}_{n} + {α}_{Λ} ) Δ T$$

where α_{Λ} is the thermal expansion coefficient of the glass, and αₙ is the thermo-optic coefficient. For example, considering germania-doped silica as the UV light sensitive glass for the BGR, α_{Λ} is about 0.55×10⁻⁶, and αₙ is about 8.6×10⁻⁶. A temperature change of about 10° C. would cause an approximate 0.01 nm shift of the Bragg wavelength.

In FIG. 6, the frequency-converted laser source 100 is configured as a folded external cavity semiconductor laser comprising a tunable wavelength selective element 58 positioned in the external cavity. The wavelength selective element 58 is configured to direct a relatively narrow band of the pump wavelength λ_{P} to the wavelength conversion device 30. More specifically, a given degree of tipping about the wavelength selective axis Y of the wavelength selective element 58 will yield a significant degree of wavelength tuning. For example, and not by way of limitation, the wavelength selective element 58 can be constructed as a ruled or holographic diffraction grating, a prism with a highly reflective coating on one of its sides, or a combination of a prism and a grating. In operation, the position of the wavelength selective element 58 is adjusted such that the wavelength selective element 58 serves as a wavelength tuning element to maintaining the operating wavelength in the center of the conversion bandwidth of the wavelength conversion device 30.

Although, the light beam emitted by the semiconductor laser can be either directly coupled into the waveguide of the wavelength conversion device 30 or can be coupled through collimating and focusing optics or some other type of suitable optical element or optical system, in the illustrated embodiment, a single lens 45 is used to couple light between the diode 15 and the wavelength conversion device 30.

Concerning the operation of the wavelength selective element 58, the basic grating equation is given by:

sin(α)+sin(β)=10⁻⁶knλ (1)

where α is the incidence angle (from normal to the surface of the grating), β is the diffraction angle, k is the diffraction order, n is the number of grooves per millimeter, and λ is the wavelength in nm. The bounce angle ν is equal to the difference of the incidence angle α and diffraction angle β:

ν=α−β (2)

If the distance from the lens 45 to the point of incidence on the diffraction grating is 3 mm, then, for the nominal vertical separation of the laser diode 15 and the wavelength conversion device 30 of 0.3 mm, the required bounce angle is ν=arcsin(0.3/3)=5.74 degrees. Changing the bounce angle by ±1 degree will shift the beam vertically by more than 100 μm, which should be more than sufficient to compensate for optical misalignments caused by environmental changes.

Rewriting equation (1) as:

$$2 sin ( \frac{α + β}{2} ) cos ( \frac{α - β}{2} ) = {10}^{- 6} kn λ \qquad ( 3 )$$

and substituting (2) into (3), we obtain:

$$α = arcsin ( \frac{{10}^{- 6} kn λ}{2 cos ( \frac{v}{2} )} ) + \frac{v}{2} \qquad ( 4 )$$

Equation (4) shows that for any bounce angle ν, which is defined by the relative position of the optical components of the system, and wavelength λ, which is dictated by the phase matching conditions of the wavelength conversion device 30, there is a unique incidence angle α, defining how the position of the wavelength selective element 58 should be adjusted to provide both wavelength selection and optimum cavity alignment. Rotation can be provided by electro-static MEMS, micro-motors or piezoelectric transducers attached to a micro-gimbal mount tip/tilt platform holding the wavelength selective element 58.

Although FIGS. 1-6 illustrate the particular case where the laser source 100 comprises a DBR, DFB, or Fabry-Perot laser diode 10, which is used as an IR pump source, and a waveguide PPLN crystal 40, which is used for frequency doubling into the green wavelength range, it is noted that the concepts of the present disclosure are equally applicable to a variety of frequency-converted laser configurations including, but not limited to, configurations that utilize frequency conversion beyond second harmonic generation (SHG). The concepts of the present disclosure are also applicable to a variety of applications in addition to laser scanning projectors.

Having described the subject matter of the present disclosure in detail and by reference to specific embodiments thereof, it will be apparent that modifications and variations are possible without departing from the scope of the invention defined in the appended claims. More specifically, although some aspects of the present disclosure are identified herein as preferred or particularly advantageous, it is contemplated that the present disclosure is not necessarily limited to these aspects.

It is noted that recitations herein of a component of the present disclosure being “configured” in a particular way, to embody a particular property, or to function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present invention it is noted that the term “approximately” is utilized herein to represent the inherent degree of uncertainty that may be attributed to any quantitative comparison, value, measurement, or other representation. The term “approximately” is also utilized herein to represent the degree by which a quantitative representation may vary from a stated reference without resulting in a change in the basic function of the subject matter at issue.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A method of operating a frequency-converted laser source comprising a laser diode, coupling optics, a wavelength conversion device, and an external reflector, wherein:
the laser diode is configured to emit a pulsed optical pump signal at a pump wavelength λ_{P} and a pulse repetition frequency ν_{P};
the laser diode, coupling optics, and external reflector are configured to define an external laser cavity between the laser diode and the external reflector along an optical path of the laser source;
the wavelength conversion device is located along the optical path of the laser source within the external laser cavity and is configured to convert the pump wavelength λ_{P} to a converted wavelength λ_{C} and transmit an unconverted pump signal λ_{P}′;
the external reflector is configured to transmit the converted wavelength λ_{C} and return at least a portion of the unconverted pump signal λ_{P}′ to a gain section of the laser diode as a self-seeding laser pulse; and
the method comprises driving the gain section of the laser diode such that the pulse repetition frequency ν_{P} is less than but sufficiently close to a mathematical reciprocal of the round-trip light flight time t_{F} of the external laser cavity, or an integer multiple thereof, to ensure that respective self-seeding laser pulses generated from the pulsed optical pump signal reach the gain section of the laser diode during buildup of successive optical pump signal pulses.

2. A method as claimed in claim 1 wherein the wavelength conversion device is also configured to convert the reflected pump wavelength λ_{P} to a converted wavelength λ_{C} and transmit an unconverted pump signal λ_{P′} as the self-seeding light of the pump laser.

3. A method as claimed in claim 1 wherein:
the method comprises driving the gain section of the laser diode such that the pulse repetition frequency ν_{P} is synchronized with the round-trip light flight time t_{F} of the external laser cavity as follows
1/m(t_{F}+τ)≦ν_{P}<m/t_{F}
where m is a positive integer, τ is the approximate pulse width of the optical pump signal pulses, and the pulse repetition frequency ν_{P} is selected to allow respective self-seeding laser pulses generated from the pulsed optical pump signal to reach the gain section of the laser diode during buildup of successive optical pump signal pulses.

4. A method as claimed in claim 1 wherein the pulse repetition frequency ν_{P} is approximately 5 GHz, the approximate pulse width τ is less than approximately 0.2 nsec, and the round-trip flight time t_{F} corresponds to an effective cavity length of about 3 cm.

5. A method as claimed in claim 1 wherein the pulse repetition frequency ν_{P} is less than approximately 10 GHz, the approximate pulse width τ is between about 0.04 nsec and about 0.2 nsec, and the round-trip flight time t_{F} corresponds to an effective cavity length of between approximately 1.5 cm and approximately 5 cm.

6. A method as claimed in claim 1 wherein the external reflector comprises a dichroic mirror that is AR coated at the converted wavelength λ_{C} and HR coated at the pump wavelength λ_{P}.

7. A method as claimed in claim 1 wherein:
a front facet of the wavelength conversion device faces the laser diode;
a rear facet of the wavelength conversion device faces the external reflector;
the front facet of the wavelength conversion device is perpendicular to the waveguide, HR coated at the converted wavelength λ_{C}, and AR coated at the pump wavelength λ_{P};
the rear facet of the wavelength conversion device is perpendicular to the waveguide, AR coated at the converted wavelength λ_{C} and the pump wavelength λ_{P}; and
the external reflector is AR coated at the converted wavelength λ_{C} and HR coated at the pump wavelength λ_{P}.

8. A method as claimed in claim 1 wherein:
a front facet of the wavelength conversion device faces the laser diode; and
the external reflector comprises a dichroic mirror applied as a coating on the rear facet of the wavelength conversion device.

9. A method as claimed in claim 1 wherein:
a front facet of the wavelength conversion device faces the laser diode;
a rear facet of the wavelength conversion device faces the external reflector;
the front facet of the wavelength conversion device is perpendicular to the waveguide, is HR coated at the converted wavelength λ_{C}, and is AR coated at the pump wavelength λ_{P};
the rear facet of the wavelength conversion device is perpendicular to the waveguide, is AR coated at the converted wavelength λ_{C}, and is HR coated at the pump wavelength λ_{P}.

10. A method as claimed in claim 1 wherein the laser diode and the external reflector form a Fabry-Perot laser diode comprising an external cavity.

11. A method as claimed in claim 10 wherein:
a front facet of the wavelength conversion device faces the laser diode;
a rear facet of the wavelength conversion device faces the external reflector;
a band-pass filter is positioned in the external cavity and is configured to transmit at the converted wavelength λ_{C} and at a relatively narrow band of the pump wavelength λ_{P};
the front facet of the wavelength conversion device is perpendicular to the waveguide, HR coated at the converted wavelength λ_{C}, and AR coated at the pump wavelength λ_{P};
the rear facet of the wavelength conversion device is AR coated at the converted wavelength λ_{C} and at the pump wavelength λ_{P}; and
the external reflector is AR coated at the converted wavelength λ_{C} and HR coated at the pump wavelength λ_{P}.

12. A method as claimed in claim 11 wherein the bandwidth of the relatively narrow band of the pump wavelength λ_{P} is less than 1 nm.

13. A method as claimed in claim 11 wherein the bandwidth of the relatively narrow band of the pump wavelength λ_{P} is less than the mode spacing of the laser diode.

14. A method as claimed in claim 11 wherein the band-pass filter comprises a tilting mechanism and is configured for tuning the relatively narrow transmission band of the band-pass filter through tilting.

15. A method as claimed in claim 10 wherein:
a front facet of the wavelength conversion device faces the laser diode;
a rear facet of the wavelength conversion device faces the external reflector; and
the external reflector comprises a Bragg grating reflector integrated into the rear facet of the wavelength conversion device.

16. A method as claimed in claim 15 wherein the Bragg grating reflector comprises control electrodes configured to alter the refractive index of the Bragg grating through application of an electric field.

17. A method as claimed in claim 15 wherein the Bragg grating reflector comprises a temperature controller configured to alter the grating period of the Bragg grating.

18. A method as claimed in claim 10 wherein:
a front facet of the wavelength conversion device faces the laser diode;
a rear facet of the wavelength conversion device faces the external reflector; and
the external reflector comprises a Bragg Grating displaced from the rear facet of the wavelength conversion device.

19. A method as claimed in claim 10 wherein the frequency-converted laser source is configured as a folded external cavity semiconductor laser comprising a wavelength selective element positioned in the external cavity and configured direct a relatively narrow band of the pump wavelength λ_{P} to the wavelength conversion device.

20. A frequency-converted laser source comprising a laser diode, coupling optics, a wavelength conversion device, and an external reflector, wherein:
the laser diode is configured to emit a pulsed optical pump signal at a pump wavelength λ_{P} and a pulse repetition frequency ν_{P};
the laser diode, coupling optics, and external reflector are configured to define an external laser cavity between the laser diode and the external reflector along an optical path of the laser source;
the wavelength conversion device is located along the optical path of the laser source within the external laser cavity and is configured to convert the pump wavelength λ_{P} to a converted wavelength λ_{C} and transmit an unconverted pump signal λ_{P}′;
the external reflector is configured to transmit the converted wavelength λ_{C} and return at least a portion of the unconverted pump signal λ_{P}′ to a gain section of the laser diode as a self-seeding laser pulse; and
the laser source is programmed to drive the gain section of the laser diode such that the pulse repetition frequency ν_{P} is less than but sufficiently close to a mathematical reciprocal of the round-trip flight time t_{F} of the external laser cavity, or an integer multiple thereof, to ensure that respective self-seeding laser pulses generated from the pulsed optical pump signal reach the gain section of the laser diode during buildup of successive optical pump signal pulses.
